(19) United States
(12) Patent Application Publication
(10) Pub. No.: US 2021/0219159 A1
(43) Pub. Date: Jul. 15, 2021

(54) INFORMATION PROCESSING APPARATUS, INFORMATION PROCESSING SYSTEM, INFORMATION PROCESSING METHOD, AND PROGRAM

(71) Applicant: Sony Corporation, Tokyo (JP)

(72) Inventors: Naoyuki Sato, Tokyo (JP); Katsuyoshi Kanemoto, Chiba (JP); Erika Saito, Tokyo (JP); Hirotaka Suzuki, Kanagawa (JP); Taichi Yuki, Kanagawa (JP); Hiroaki Takano, Saitama (JP)

(73) Assignee: Sony Corporation, Tokyo (JP)

(21) Appl. No.: 17/058,093

(22) PCT Filed: Mar. 12, 2019
(86) PCT No.: PCT/JP2019/010020

§ 371 Date: Nov. 23, 2020

(30) Foreign Application Priority Data
May 31, 2018 (JP) 2018-104392

(51) Int. Cl. H04W 24/10; H04W 24/02; H04W 4/029

(52) U.S. Cl. CPC H04W 24/10; H04W 4/029; H04W 24/02

(57) ABSTRACT

It is made possible to perform a data analysis and a search process using devices set definition information, which is definition information in a unit of a devices set including a plurality of devices. A data providing apparatus that generates devices set definition information, which is definition information in a unit of a devices set including a plurality of devices, and registers the devices set definition information in a database, and a data analyzing apparatus and a data using apparatus that acquire the devices set definition information from the database and perform a data analysis process or a search process to which the acquired devices set definition information is applied are included. Data analyses and search processes with the devices set definition information achieve improved processing efficiency and generation of various analysis results.

### TECHNICAL FIELD

The present disclosure relates to an information processing apparatus, an information processing system, an information processing method, and a program. More specifically, the present invention relates to an information processing apparatus, an information processing system, an information processing method, and a program that achieve information collection and analysis processing using Internet of Things (IoT) devices such as a plurality of sensors.

### BACKGROUND ART

Recently, development of information collection and analysis processing using so-called Internet of Things (IoT) devices, which are ordinary things connected to a network to transmit and receive data, has been actively promoted.

Note that Patent Document 1 (Japanese Patent Application Laid-Open No. 2016-045964) is an example of the conventional art that has made a disclosure about information collection and analysis processing with IoT devices.

### CITATION LIST

### Patent Document

Patent Document 1: Japanese Patent Application Laid-Open No. 2016-045964

### SUMMARY OF THE INVENTION

### Problems to be Solved by the Invention

In conventional configurations based on IoT devices including the configuration described in Patent Document 1 above, for example, definitions of the performance, data acquisition method, and the like of an IoT device such as a sensor are often individually provided in a unit of a single device (sensor) and, during a data analysis process, an analysis is often conducted by using the definition information in a unit of such single device (sensor).

However, for example, in a case of conducting an analysis with information acquired from a large number of IoT devices such as sensors, acquiring the performance of each device separately to conduct the analysis reduces the efficiency of data processing. Furthermore, the information acquired from a plurality of devices (sensors) often represents information having a much greater amount and being more diverse than information acquired from a single device (sensor).

The present disclosure has been made in view of, for example, the above-described problems, and an object of the present disclosure is to provide an information processing apparatus, an information processing system, an information processing method, and a program that achieve improving processing efficiency and acquiring further diverse analysis data by conducting an analysis or by a data user's searching or using data with definitions of the performance, data acquisition method, and the like in a unit of a set of a plurality of devices.

### Solutions to Problems

According to a first aspect of the present disclosure, an information processing apparatus includes:

a data processing unit that performs a data analysis process using device-detected information, in which

the data processing unit acquires devices set definition information, which is definition information in a unit of a devices set including a plurality of devices, and performs the data analysis process to which the acquired devices set definition information is applied.

Moreover, according to a second aspect of the present disclosure, an information processing apparatus includes:

a data processing unit that performs a data search process using device-detected information, in which

the data processing unit acquires devices set definition information, which is definition information in a unit of a devices set including a plurality of devices, and performs the data search process to which the acquired devices set definition information is applied.

Moreover, according to a third aspect of the present disclosure, an information processing apparatus includes:

a data processing unit that generates devices set definition information, which is definition information in a unit of a devices set including a plurality of devices, and registers the devices set definition information in a database.

Moreover, according to a fourth aspect of the present disclosure, an information processing system includes:

a data providing apparatus that generates devices set definition information, which is definition information in a unit of a devices set including a plurality of devices, and registers the devices set definition information in a database; and

a data analyzing apparatus that acquires the devices set definition information from the database and performs a data analysis process to which the acquired devices set definition information is applied.

Moreover, according to a fifth aspect of the present disclosure, an information processing method is performed in an information processing apparatus, in which

the information processing apparatus includes a data processing unit that performs a data analysis process using device-detected information, and

the information processing method includes:

acquiring devices set definition information, which is definition information in a unit of a devices set including a plurality of devices, and performing the data analysis process to which the acquired devices set definition information is applied, the acquiring and the performing being carried out by the data processing unit.

Moreover, according to a sixth aspect of the present disclosure, an information processing method is performed in an information processing apparatus, in which

the information processing apparatus includes a data processing unit that performs a data search process using device-detected information, and

the information processing method includes:

acquiring devices set definition information, which is definition information in a unit of a devices set including a plurality of devices, and performing the data search process to which the acquired devices set definition information is applied, the acquiring and the performing being carried out by the data processing unit.

According to a seventh aspect of the present disclosure, a program causes an information processing apparatus to perform information processing, in which

the information processing apparatus includes a data processing unit that performs a data analysis process using device-detected information, and

the program causes the data processing unit to:

acquire devices set definition information, which is definition information in a unit of a devices set including a plurality of devices, and perform the data analysis process to which the acquired devices set definition information is applied.

According to an eighth aspect of the present disclosure, a program causes an information processing apparatus to perform information processing, in which

the information processing apparatus includes a data processing unit that performs a data search process using device-detected information, and

the program causes the data processing unit to:

acquire devices set definition information, which is definition information in a unit of a devices set including a plurality of devices, and perform the data search process to which the acquired devices set definition information is applied.

The program of the present disclosure is a program that can be provided on a storage medium or a communication medium provided in a computer-readable format to, for example, an information processing apparatus or a computer system that can execute various program codes. By providing such program in a computer-readable format, processing is achieved in accordance with the program on the information processing apparatus or the computer system.

Still other objects, features, and advantages of the present disclosure will be apparent from the more detailed description on the basis of examples of the present disclosure as described later and the accompanying drawings. Note that the system as used herein is a logical assembly of a plurality of apparatuses, and the apparatuses having their respective configurations may not necessarily be in the same housing.

### Effects of the Invention

According to the configuration of one example of the present disclosure, a configuration is implemented making it possible to perform a data analysis and a search process using devices set definition information, which is definition information in a unit of a devices set including a plurality of devices.

Specifically, the configuration includes, for example, a data providing apparatus that generates devices set definition information, which is definition information in a unit of a devices set including a plurality of devices, and registers the devices set definition information in a database, and a data analyzing apparatus and a data using apparatus that acquire the devices set definition information from the database and perform a data analysis process or a search process to which the acquired devices set definition information is applied. Data analyses and search processes with the devices set definition information achieve improved processing efficiency and generation of various analysis results.

According to this configuration, a configuration is implemented making it possible to perform a data analysis and a search process using devices set definition information, which is definition information in a unit of a devices set including a plurality of devices.

Note that the effects described herein are examples only and are not restrictive, and additional effects may be provided.

### BRIEF DESCRIPTION OF DRAWINGS

FIG. 1 is an explanatory diagram illustrating an example of setting a devices set.

FIG. 2 is an explanatory diagram illustrating an example of devices set definition information.

FIG. 3 is an explanatory diagram illustrating an example configuration of an information processing system of the present disclosure.

FIG. 4 is an explanatory diagram illustrating an example process of acquiring detected information using a devices set.

FIG. 5 is an explanatory diagram illustrating an example of information regarding a devices set.

FIG. 6 is an explanatory diagram illustrating an example of devices set definition information.

FIG. 7 is an explanatory diagram illustrating an example of data acquirer registered information and data provider registered information.

FIG. 8 is a diagram showing a flowchart for explaining sequence of a process of registering devices set definition.

FIG. 9 is a diagram showing a flowchart for explaining sequence of a process of registering devices set definition.

FIG. 10 is a diagram showing a flowchart for explaining sequence of a data analysis process and a process of registering an analysis result.

FIG. 11 is a diagram showing a flowchart for explaining sequence of a data search process.

FIG. 12 is a diagram showing a flowchart for explaining sequence of a data search process.

FIG. 13 is a diagram showing a flowchart for explaining sequence of a data acquisition process.

FIG. 14 is a diagram showing a flowchart for explaining sequence of a data acquisition process.

FIG. 15 is an explanatory diagram illustrating an example of a database configuration and registered information.

FIG. 16 is an explanatory diagram illustrating a process of giving generation information and the like to the data recorded in a database.

FIG. 17 is an explanatory diagram illustrating a process of giving generation information and the like to the data recorded in a database.

FIG. 18 is an explanatory diagram illustrating a process of giving generation information and the like to the data recorded in a database.

FIG. 19 is an explanatory diagram illustrating a process of giving generation information and the like to the data recorded in a database.

FIG. 20 is an explanatory diagram illustrating an example of a data crawling process.

FIG. 21 is an explanatory diagram illustrating an example of crawling data.

FIG. 22 is an explanatory diagram illustrating an example of a user interface.

FIG. 23 is an explanatory diagram illustrating an example of a user interface.

FIG. 24 is an explanatory diagram illustrating an example of a user interface.

FIG. 25 is an explanatory diagram illustrating an example of a user interface.

FIG. 26 is an explanatory diagram illustrating an example hardware configuration of an information processing apparatus.

### MODE FOR CARRYING OUT THE INVENTION

An information processing apparatus, an information processing system, an information processing method, and a program of the present disclosure will now be described in detail with reference to the drawings. Note that the description will be given in accordance with the following items.

1. Outline processes and devices set definition information of the present disclosure

2. Example configuration of the information processing system that performs processes of the present disclosure

3. Specific examples of processes performed by the information processing system of the present disclosure

4. Sequence of processes performed in the information processing system

5. Database-stored data

6. Configuration enabling origins and generations of database-stored data to be identified

7. Examples in which data on a network is collected and stored into databases of the information registration and search server

8. Example UIs usable for processes including a data search process

9. Example hardware configuration of the information processing apparatus

10. Summary of configurations of the present disclosure

### 1. Outline Processes and Devices Set Definition Information of the Present Disclosure

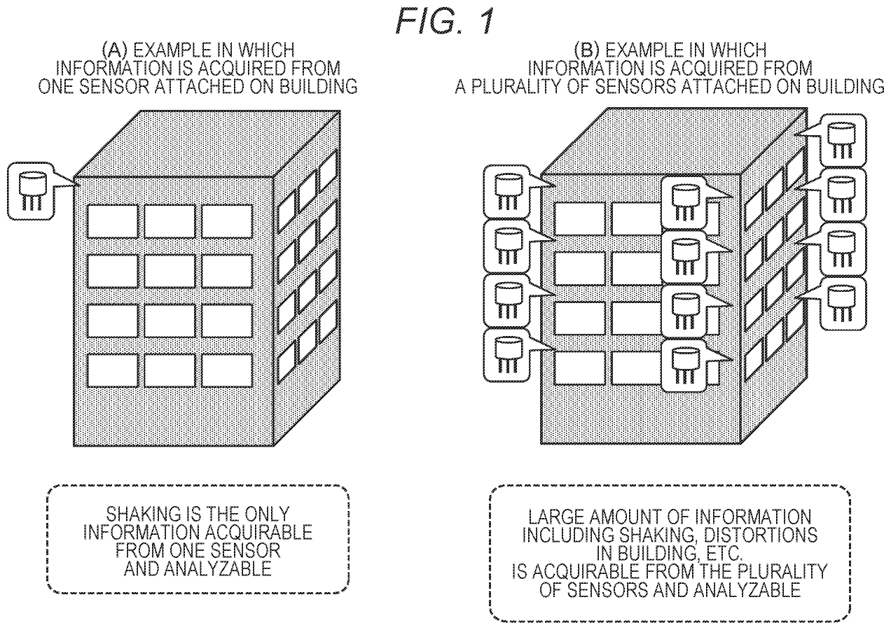

First, referring to the figures from FIG. 1, the following describes outline processes and devices set definition information of the present disclosure.

For example, in a case where information acquired from an IoT device such as a sensor is analyzed, a typical conventional method includes providing individual definitions in a unit of a single device (sensor), that is, definitions of the performance, data acquisition method, and the like of a sensor, and conducting a data analysis using the definitions. However, in a case of conducting an analysis with information acquired from a large number of IoT devices such as sensors, acquiring the performance of each device separately to conduct the analysis leads to reducing the efficiency of data processing. Furthermore, the information acquired from a plurality of devices (sensors) often represents information having a much greater amount and being more diverse than information acquired from a single device (sensor).

Processes of the present disclosure make it possible to conduct a data analysis using definitions of the performance, data acquisition method, and the like in a unit of a set of a plurality of devices, and further make it possible for the data user to search and use data in a unit of the set, whereby the efficiency of data processing is improved and more diverse analysis data can be obtained.

FIG. 1 is an explanatory diagram illustrating an example of a process of the present disclosure. FIG. 1(A) shows an example in which information acquired from one sensor attached on a building is analyzed, while FIG. 1(B) shows an example in which information acquired from a large number of sensors attached on a building is analyzed.

As shown in (A), with only the information acquired from one sensor attached on a building, merely the shaking of the entire building can be understood.

On the other hand, as shown in (B), by analyzing the information acquired from a large number of sensors attached on the building, a larger amount of information including not only the shaking of the entire building but also, for example, distortions, stresses, and the like created in various portions of the building can be acquired and analyzed.

The data defined in a unit of a set of a plurality of devices will differ depending on the types and uses of the devices.

For example, in the case of devices (sensors) attached on a building as shown in FIG. 1, pieces of data as below are defined in a unit of a devices set including a plurality of devices (sensor):

(1) Location and building where devices are attached;

(2) Uses of devices (such as shaking, earthquake observation, distortion measurement, and the like);

(3) The number of devices included in the set;

(4) Device type (such as accelerometer);

(5) Device manufacturer;

(6) Data acquisition method;

(7) Measurement frequency;

(8) Usage fee (usage fee for using measurement data and analysis data); and

(9) Reliability of device measurement data.

For example, these pieces of data are defined in a unit of a set of a plurality of devices.

By using the definition data in a unit of a devices set, it is made possible to efficiently perform a process of analyzing the data acquired by the devices, and to perform a process of searching or using the data acquired by the devices or the analysis data.

Note that the definition data in a unit of a devices set is stored in a database (devices set definition DB). Data analysts and data users can analyze, search, and use the data by using the definition data in a unit of a devices set stored in the devices set definition DB.

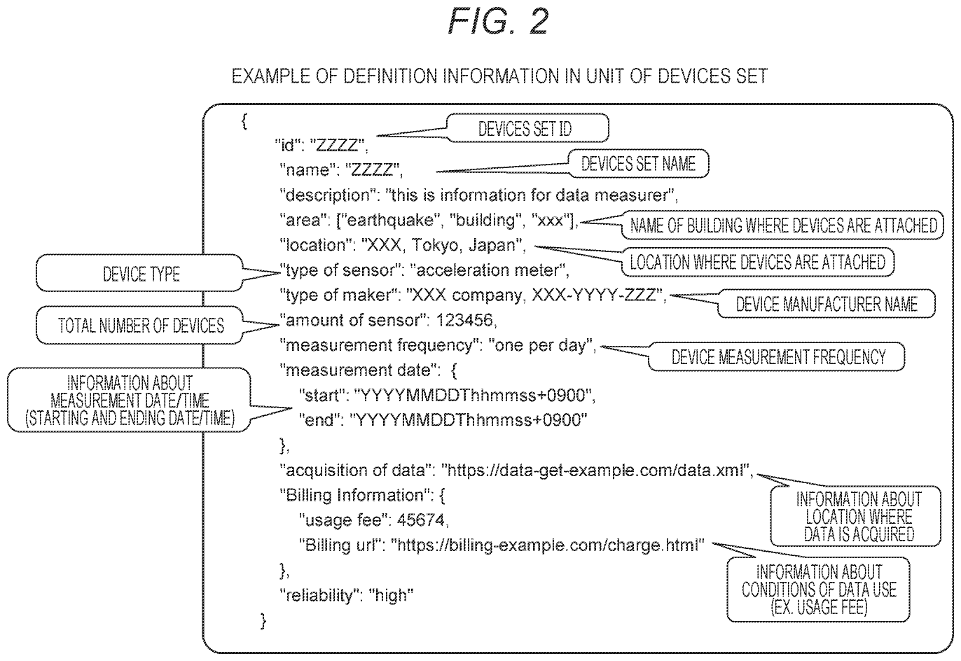

FIG. 2 is a diagram showing an example of the definition information in a unit of a devices set stored in the devices set definition DB.

In the example shown in FIG. 2, information including devices set ID, devices set name, name of building where devices are attached, location where devices are attached (location), device type (type of device), device manufacturer name, total number of devices, device measurement frequency, information regarding measurement date/time (starting and ending date/time), information regarding location where data is acquired, and information regarding conditions of data use (such as usage fee) is registered as the definition information in a unit of a devices set. This information is stored in the devices set definition DB and made available to data analysts and data users.

### 2. Example Configuration of the Information Processing System that Performs Processes of the Present Disclosure

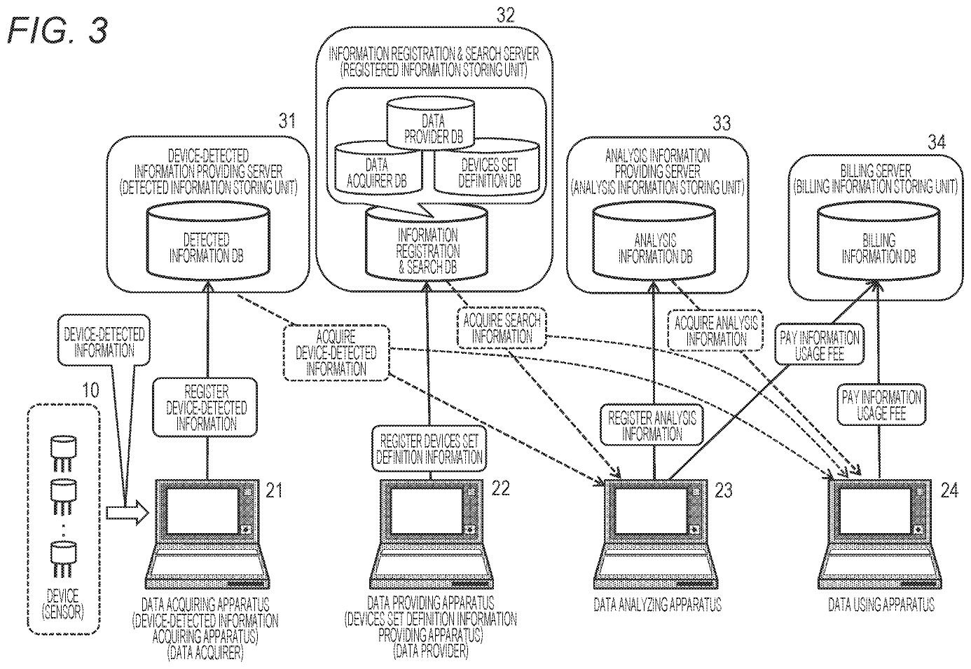

Referring to FIG. 3, the following describes an example configuration of the information processing system that performs processes of the present disclosure.

FIG. 3 is a diagram illustrating an example configuration of the information processing system that performs processes of the present disclosure.

The information processing system includes a data acquiring apparatus 21, a data providing apparatus 22, a data analyzing apparatus 23, a data using apparatus 24, a device-detected information providing server (detected information storing unit) 31, an information registration and search server (registered information storing unit) 32, an analysis information providing server (analysis information storing unit) 33, and a billing server (billing information storing unit) 34.

The data acquiring apparatus 21, which is an apparatus that acquires device-detected information, acquires detected information from a devices set 10 including a plurality of devices.

Note that apparatus information and administrator information (data provider information) pertaining to the data acquiring apparatus 21 are stored in a data acquirer DB of the information registration and search server (registered information storing unit) 32.

The data acquiring apparatus 21 stores the device-detected information acquired from the devices set 10 including a plurality of devices into a detected information DB of the device-detected information providing server (detected information storing unit) 31.

The data providing apparatus 22, which is an apparatus that provides devices set definition information, generates definition information regarding the devices set 10 including a plurality of devices, and stores the definition information into the devices set definition DB of the information registration and search server (registered information storing unit) 32.

Note that apparatus information and administrator information (data provider information) pertaining to the data providing apparatus 22 are stored in a data provider DB of the information registration and search server (registered information storing unit) 32.

The data analyzing apparatus 23 acquires device-detected information stored in the detected information DB of the device-detected information providing server (detected information storing unit) 31 or devices set definition information stored in the devices set definition DB of the information registration and search server (registered information storing unit) 32 to perform various data analysis processes.

In other words, the data analyzing apparatus 23 includes a data processing unit that performs a data analysis process using the device-detected information, and the data processing unit acquires devices set definition information, which is the definition information in a unit of a devices set including a plurality of devices, and performs a data analysis process to which the acquired devices set definition information is applied.

For example, an analysis of distortions created in various portions of a building can be conducted on the basis of the information detected by a plurality of sensors attached on the building, as described above with reference to FIG. 1.

Analysis result data obtained as a result of the analysis process performed by the data analyzing apparatus 23 is stored in an analysis information DB of the analysis information providing server (analysis information storing unit) 33.

The data using apparatus 24 is an apparatus that uses information such as device-detected information stored in the detected information DB of the device-detected information providing server (detected information storing unit) 31, devices set definition information stored in the devices set definition DB of the information registration and search server (registered information storing unit) 32, or analysis information stored in the analysis information DB of the analysis information providing server (analysis information storing unit) 33.

The data using apparatus 24 includes a data processing unit that performs, for example, a data analysis process using the device-detected information, and the data processing unit acquires devices set definition information, which is the definition information in a unit of a devices set including a plurality of devices, and performs processes including a data search process to which the acquired devices set definition information is applied.

The data using apparatus 24 is, for example, an apparatus such as a PC or a mobile terminal used by a general user or the like.

Note that a billing process is performed, if necessary, for use of data. The billing process is performed by the billing server (billing information storing unit) 34, and the billing information is stored in a billing information DB. Note that the billing process is also performed, if necessary, when the data analyzing apparatus 23 acquires device-detected information stored in the detected information DB of the device-detected information providing server (detected information storing unit) 31 or devices set definition information stored in the devices set definition DB of the information registration and search server (registered information storing unit) 32.

FIG. 3 shows the following apparatuses one by one: the data acquiring apparatus 21, the data providing apparatus 22, the data analyzing apparatus 23, the data using apparatus 24, the device-detected information providing server (detected information storing unit) 31, the information registration and search server (registered information storing unit) 32, the analysis information providing server (analysis information storing unit) 33, and the billing server (billing information storing unit) 34. In this configuration, each of these apparatuses is connected to one another via a network.

Furthermore, in another configuration, a single apparatus may have functions of a plurality of different apparatuses including the data acquiring apparatus 21, the data providing apparatus 22, the data analyzing apparatus 23, and the data using apparatus 24.

Similarly, in another configuration, a single server may have functions of a plurality of individual servers including the device-detected information providing server (detected information storing unit) 31, the information registration and search server (registered information storing unit) 32, the analysis information providing server (analysis information storing unit) 33, and the billing server (billing information storing unit) 34.

### 3. Specific Examples of Processes Performed by the Information Processing System of the Present Disclosure

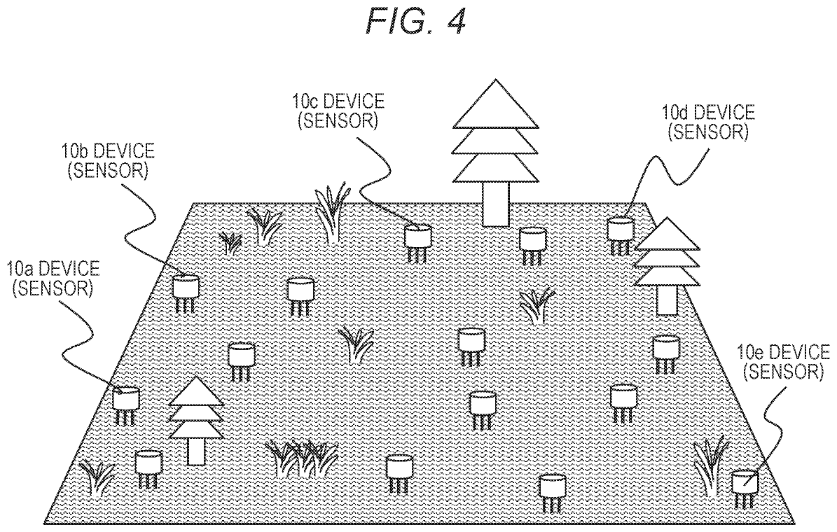

Referring to the figures from FIG. 4, the following describes specific examples of processes performed by the information processing system of the present disclosure.

The following describes an example in which a devices set including a plurality of sensors distributed over a soil is applied as illustrated in FIG. 4.

As shown in FIG. 4, in the configuration, devices (sensors) 10a, 10b, 10c, . . . are attached to various positions in, for example, a farm to acquire detected information from each device. Each device is, for example, a pH sensor that measures the acidity, alkalinity, and the like of the soil.

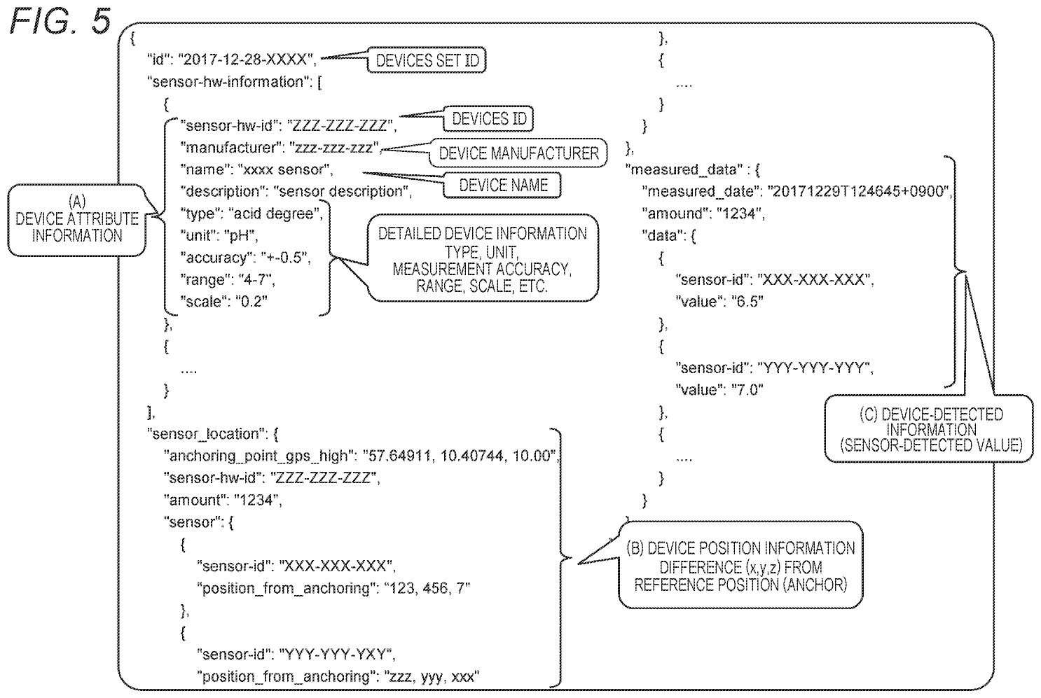

FIG. 5 shows an example of the data summarizing the information regarding a devices set including the plurality of pH sensors and the information regarding measurement by the devices.

FIG. 5 shows the following types of information regarding the devices set including the plurality of pH sensors illustrated in FIG. 4.

(A) Device attribute information

(B) Device position information

(C) Device-detected information

Note that an ID of the devices set (devices set ID) is recorded at the head of the data in FIG. 5.

(A) Device attribute information includes the following pieces of data:

device ID;

device manufacturer;

device name; and

detailed device information (type, unit, measurement accuracy, range, scale, and the like).

(B) Device position information includes fields in which the position information regarding each device is recorded. For example, amounts of shift (x, y, z) of each device in three-dimensional directions from a predetermined reference position (anchor) are recorded.

(C) Device-detected information includes areas in which information detected by each device is recorded.

These pieces of information are acquired by the data acquiring apparatus 21 and stored in the detected information DB of the device-detected information providing server (detected information storing unit) 31.

Note that (A) Device attribute information and (B) Device position information can be acquired by the data acquiring apparatus 21 from the data providing apparatus 22 or from the devices set definition DB of the information registration and search server (registered information storing unit) 32.

The data providing apparatus 22 registers devices set definition information beforehand in the devices set definition DB of the information registration and search server (registered information storing unit) 32.

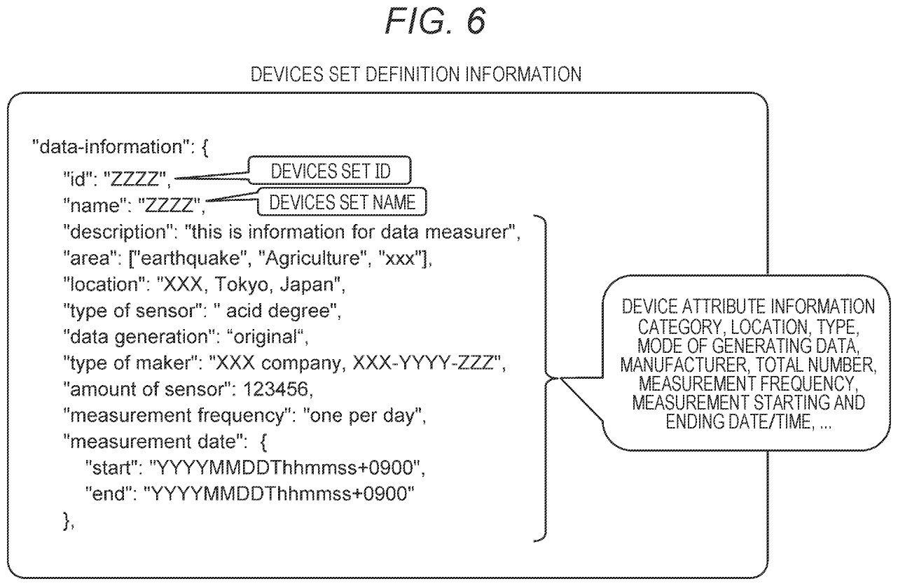

FIG. 6 shows a specific example of the devices set definition information.

The devices set definition information shown in FIG. 6 is definition information regarding a devices set including the plurality of pH sensors illustrated in FIG. 4. For example, the following pieces of data are registered.

(1) Devices set ID

(2) Devices set name

(3) Device attribute information

The device attribute information includes information such as device type, device location, mode of generating data, device manufacturer, the total number of devices, measurement frequency, measurement starting and ending date/time, and the like.

The devices set definition information is stored in the devices set definition DB of the information registration and search server (registered information storing unit) 32 by the data providing apparatus 22.

Moreover, the apparatus information and administrator information pertaining to the data acquiring apparatus 21 and the data providing apparatus 22 illustrated in FIG. 3 are also registered beforehand in the data acquirer DB and the data provider DB, respectively, of the information registration and search server (registered information storing unit) 32.

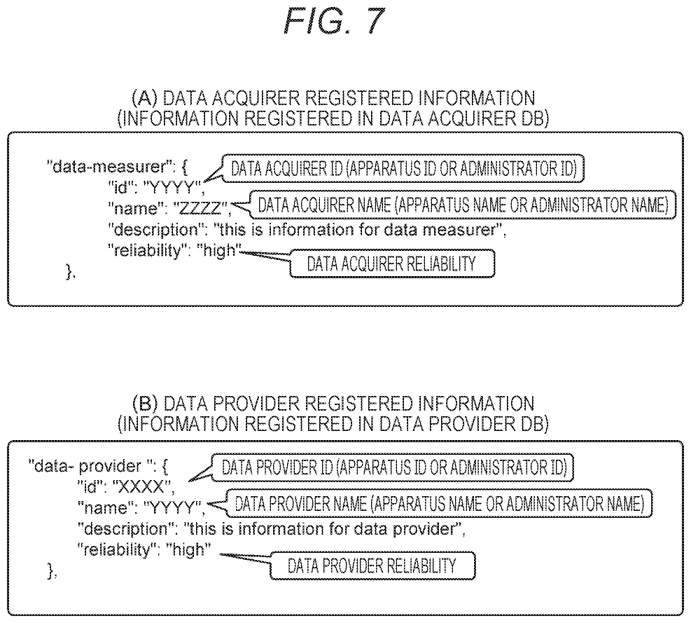

FIG. 7 shows examples of these pieces of registered information.

The pieces of data below are recorded in (A) Data acquirer registered information shown in FIG. 7.

(1) Data acquirer ID (at least any one of an apparatus ID or an administrator ID)

(2) Data acquirer name (at least any one of an apparatus name or an administrator name)

(3) Data acquirer reliability information.

These pieces of information are stored in the data acquirer DB of the information registration and search server (registered information storing unit) 32.

Furthermore, the pieces of data below are recorded in (B) Data provider registered information shown in FIG. 7.

(1) Data provider ID (at least any one of an apparatus ID or an administrator ID)

(2) Data provider name (at least any one of an apparatus name or an administrator name)

(3) Data provider reliability information

These pieces of information are stored in the data provider DB of the information registration and search server (registered information storing unit) 32.

### 4. Sequence of Processes Performed in the Information Processing System

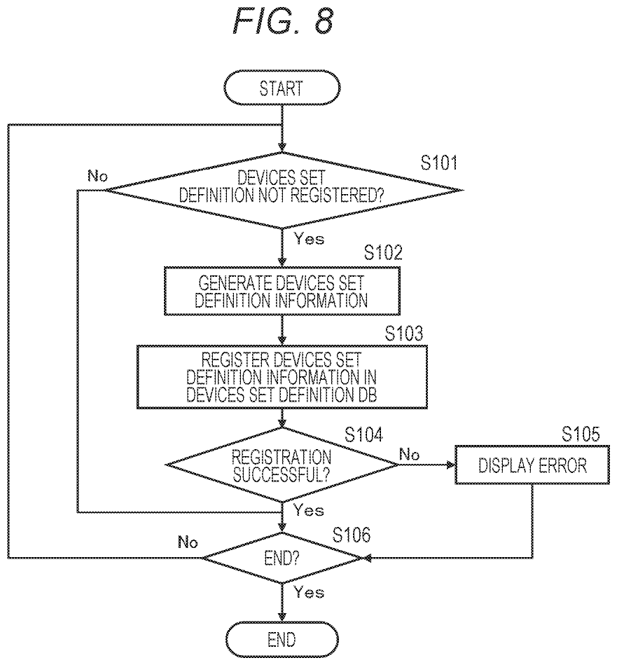

Referring to each of the flowcharts in the figures from FIG. 8, the following describes sequence of processes performed in the information processing system of the present disclosure as described with reference to FIG. 3.

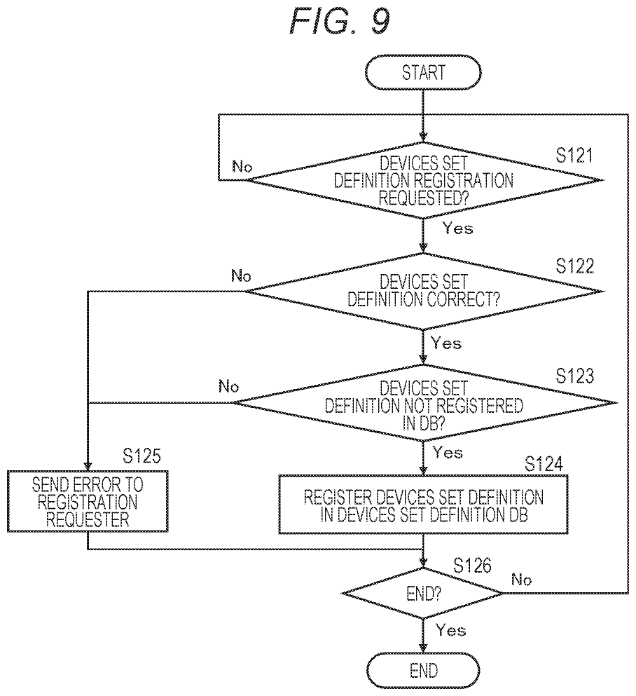

First, the sequence of a process of registering devices set definition information is described with reference to the flowcharts shown in FIGS. 8 and 9.

The process of registering devices set definition information is performed by the data providing apparatus 22 and the information registration and search server (registered information storing unit) 32 illustrated in FIG. 3.

FIG. 8 shows a flow for explaining the sequence of a process to be performed by the data providing apparatus 22, while FIG. 9 shows a flow for explaining the sequence of a process to be performed by the information registration and search server (registered information storing unit) 32.

First, the following describes the sequence of the process to be performed by the data providing apparatus 22, referring to the flow shown in FIG. 8.

The data providing apparatus 22 performs a process of registering and storing, for example, the devices set definition information described above with reference to FIG. 6 in the devices set definition DB of the information registration and search server (registered information storing unit) 32. The following describes step by step the individual process steps in the flowchart shown in FIG. 8.

(Step S101)

First, in step S101, the data providing apparatus 22 determines whether or not devices set definition information is registered and stored in the devices set definition DB of the information registration and search server (registered information storing unit) 32.

If the definition information is already registered, the processing goes to step S106 to determine whether or not the process is to be ended.

If the definition information is not registered yet, the processing goes to step S102.

(Step S102)

If it is determined in step S101 that devices set definition information is not registered or stored in the devices set definition DB of the information registration and search server (registered information storing unit) 32, the data providing apparatus 22 generates devices set definition information in step S102. For example, devices set definition information including the information described above with reference to FIG. 6 is generated.

(Step S103)

Next, in step S103, the data providing apparatus 22 registers and stores the devices set definition information that has been generated in step S102 in the devices set definition DB of the information registration and search server (registered information storing unit) 32.

(Steps S104 and S105)

Next, in step S104, the data providing apparatus 22 determines whether or not the process of registering and storing the devices set definition information in the devices set definition DB has been successful. For example, verification is performed on the basis of a notification of registration status from the information registration and search server (registered information storing unit) 32. If the process has been unsuccessful, the processing goes to step S105 to display an error notification, and then goes to step S106.

If the process has been successful, the processing goes to step S106.

(Step S106)

Next, in step S104, the data providing apparatus 22 determines whether or not to end the process of registering the devices set definition information.

For example, if the registration process has been successful, the process is ended. If the process has been unsuccessful, the processing returns to step S101 to perform the process again.

In accordance with the process flow shown in FIG. 8, the devices set definition information containing, for example, the data described above with reference to FIG. 6 is registered and stored in the devices set definition DB of the information registration and search server (registered information storing unit) 32.

Referring to the flowchart shown in FIG. 9, the following describes the sequence of a process to be performed by the information registration and search server (registered information storing unit) 32 during the process of registering devices set definition information.

(Step S121)

First, in step S121, the information registration and search server (registered information storing unit) 32 determines whether or not a request for registering devices set definition information has been received from the information providing apparatus 22. When a request for registering devices set definition information has been received from the information providing apparatus 22, the processing goes to step S122.

(Step S122)

When it is determined in step S121 that a request for registering devices set definition information has been received from the information providing apparatus 22, then in step S122, the information registration and search server (registered information storing unit) 32 verifies the format of the received devices set definition information to determine whether or not the definition information is in a correct format with necessary information included. If the format is correct, the processing goes to step S123.

If the format is incorrect, the processing goes to step S125 to give notification of an error message to the registration requester.

(Step S123)

If it is determined that the format of the received devices set definition information is correct, in step S123, the information registration and search server (registered information storing unit) 32 checks whether or not the devices set definition for which the registration request has been made is unregistered in the devices set definition DB.

If the definition is not registered yet, the processing goes step S124. If the definition is already registered, the processing goes to step S125 to give notification of an error message to the registration requester.

(Step S124)

In step S124, the information registration and search server (registered information storing unit) 32 registers the devices set definition for which the registration request has been made in the devices set definition DB.

(Step S126)

Finally, in step S126, the information registration and search server (registered information storing unit) 32 determines whether or not to end the process of registering devices set definition information.

For example, if the registration process has been successful, the process is ended. If the process has been unsuccessful, the processing returns to step S1261 to perform the process again.

In accordance with the process flows shown in FIG. 8 as described above and in FIG. 9, the process of registering and storing the devices set definition information containing, for example, the data described above with reference to FIG. 6 in the devices set definition DB of the information registration and search server (registered information storing unit) 32 is performed.

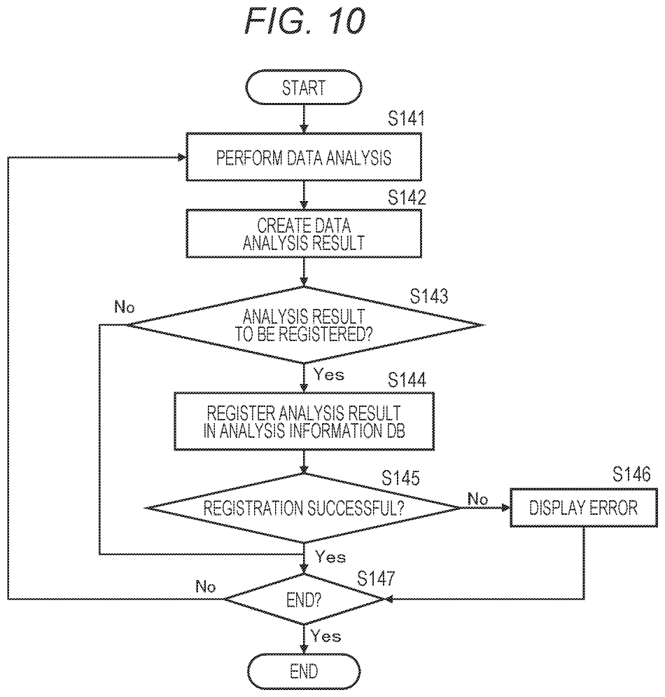

Referring to the flowchart shown in FIG. 10, the following describes the sequence of a process of analyzing data performed by the data analyzing apparatus 23 illustrated in FIG. 3 and a process of storing an analysis result into the analysis information DB. The following describes the individual process steps in the flowchart shown in FIG. 10.

(Step S141)

First, in step S141, the data analyzing apparatus 23 performs a data analysis process. The data analyzing apparatus 23 acquires device-detected information stored in the detected information DB of the device-detected information providing server (detected information storing unit) 31 or devices set definition information stored in the devices set definition DB of the information registration and search server (registered information storing unit) 32 to perform various data analysis processes.

For example, an analysis of distortions and the like created in various portions of a building is conducted on the basis of the information detected by a plurality of sensors attached on the building, as described above with reference to FIG. 1.

(Steps S142 and 143)

In step S142, the data analyzing apparatus 23 generates an analysis result including the result data of the analysis process in step S141.

Moreover, in step S143, it is determined whether or not the analysis result is to be registered in the database. If the data is to be registered, the processing goes to step S144. If the data is not to be registered, the processing goes to step S147.

(Step S144)

If it is determined that the analysis result is to be registered in the database in step S143, the data analyzing apparatus 23 performs, in step S144, the process of registering the analysis result in the analysis information DB of the analysis information providing server 33.

(Steps 5145 and 5146)

Next, in step S145, the data analyzing apparatus 23 determines whether or not the process of registering the analysis result in the analysis information DB has been successful. For example, verification is performed on the basis of a notification of registration status from the analysis information providing server (analysis information storing unit) 33. If the process has been unsuccessful, the processing goes to step S146 to display an error notification, and then goes to step S147.

If the process has been successful, the processing goes to step S147.

(Step S147)

Next, in step S147, the data analyzing apparatus 23 determines whether or not to end the process of registering the analysis result.

For example, if the registration process has been successful, the process is ended. If the process has been unsuccessful, the processing returns to step S141 to perform the process again.

Note that the data analyzing apparatus 23 includes, for example, a data processing unit that performs a data analysis process using the device-detected information. The data processing unit acquires devices set definition information, which is the definition information in a unit of a devices set including a plurality of devices, to perform the data analysis process to which the acquired devices set definition information is applied.

The following describes the sequence of a data search process performed by the data using apparatus 24 illustrated in FIG. 3.

The data using apparatus 24 is an apparatus that uses information such as device-detected information stored in the detected information DB of the device-detected information providing server (detected information storing unit) 31, devices set definition information stored in the devices set definition DB of the information registration and search server (registered information storing unit) 32, or analysis information stored in the analysis information DB of the analysis information providing server (analysis information storing unit) 33.

The data using apparatus 24 is, for example, an apparatus such as a PC or a mobile terminal used by a general user or the like.

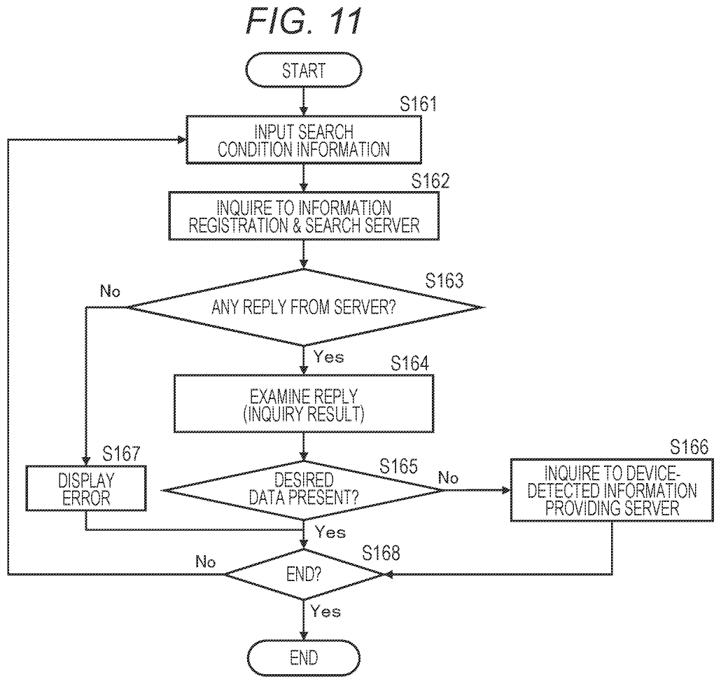

The following describes the individual process steps in the flowchart shown in FIG. 11.

(Step S161)

First, in step S161, the data using apparatus 24 inputs a predetermined search condition. For example, search condition information representing a desire to acquire soil information regarding a certain region is input. This information is used for, for example, acquiring device-detected information obtained from, for example, a devices set including the plurality of pH sensors described above with reference to FIG. 4.

(Step S162)

Next, in step S162, the data using apparatus 24 transmits the search condition information that has been input in step S161 to the information registration and search server 32 to inquire whether or not the information matching the search condition can be acquired.

(Step S163)

Next, in step S163, the data using apparatus 24 determines whether or not the information registration and search server 32 has made a reply. If any reply has been made, the processing goes to step S164. If no reply has been made, the processing goes to step S167 to display an error message and goes to step s168.

(Steps S164 and 165)

Next, in step S164, the data using apparatus 24 examines the reply from the information registration and search server 32 to determine whether or not there is any data desired to be used. If there is no data desired to be used, the processing goes to step SS168. If there is any data desired to be used, the processing goes to step S166.

(Step S166)

If it is determined in step S165 that there is data desired to be used, in step S166, the data using apparatus 24 makes an inquiry to the device-detected information providing server 31 to acquire information that matches the search condition.

(Step S168)

Finally, in step S168, the data using apparatus 24 determines whether or not to end the search process.

For example, if the process of acquiring the desired data has been successful, the process is ended. If the process has been unsuccessful, the processing returns to step S161 to perform the process again.

Note that the data using apparatus 24 includes a data processing unit that performs, for example, a data analysis process using the device-detected information, and the data processing unit acquires, for example, devices set definition information, which is the definition information in a unit of a devices set including a plurality of devices, and performs processes including the data search process to which the acquired devices set definition information is applied.

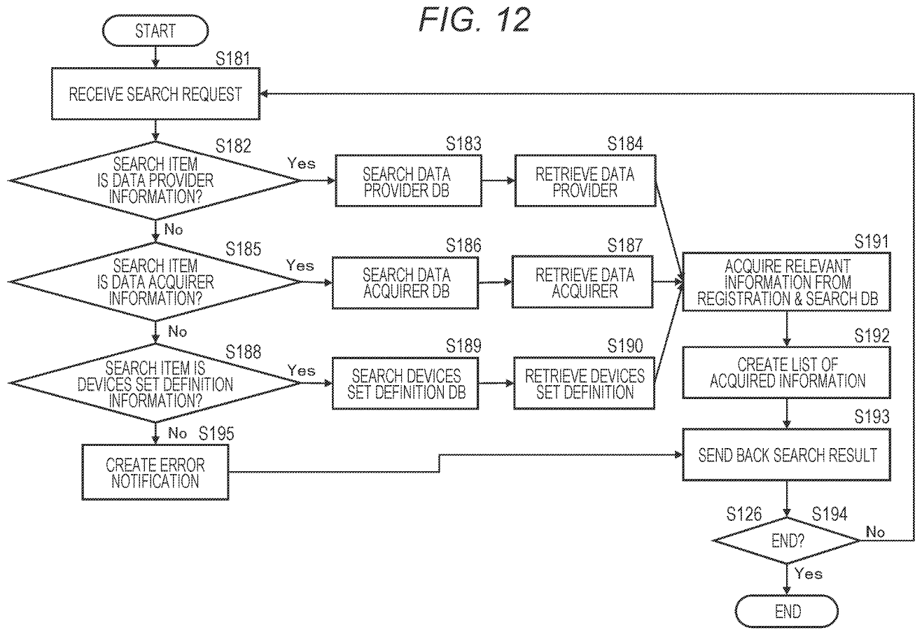

Referring to the flowchart shown in FIG. 12, the following describes the sequence of a process to be performed by the information registration and search server 32 when a search request is received from the data using apparatus 24 or the like. The following describes the individual process steps in the flowchart shown in FIG. 12.

(Step S181)

First, in step S181, the information registration and search server 32 receives a request for data search. For example, a request for data search is received from the data using apparatus 24 or the data analyzing apparatus 23.

(Step S182)

Then, in step S182, the information registration and search server 32 determines whether or not the search item of the received search request is a data provider. If the search item of the search request is a data provider, the processing goes to step S183. If the search item of the search request is not a data provider, the processing goes to step S185.

(Steps S183 and S184)

If it is determined in step S182 that the search item of the search request is a data provider, the processing goes to step S183. In step S183, the information registration and search server 32 searches the data provider DB in accordance with the search request received in step S181, and retrieves a search result in step S184.

(Step S185)

On the other hand, if it is determined in step S182 that the search item of the search request is not a data provider, the processing goes to step S185. In step S185, the information registration and search server 32 determines whether or not the search item of the received search request is a data acquirer. If the search item of the search request is a data acquirer, the processing goes to step S186. If the search item of the search request is not a data acquirer, the processing goes to step S188.

(Steps S186 and S187)

If it is determined in step S185 that the search item of the search request is a data acquirer, the processing goes to step S186. In step S186, the information registration and search server 32 searches the data acquirer DB in accordance with the search request received in step S181, and retrieves a search result in step S187.

(Step S188)

On the other hand, if it is determined in step S185 that the search item of the search request is not a data acquirer, the processing goes to step S188. In step S188, the information registration and search server 32 determines whether or not the search item of the received search request is devices set definition information. If the search item of the search request is devices set definition information, the processing goes to step S189. If the search item of the search request is not devices set definition information, the processing goes to step S195 to generate an error notification message and, in step S193, sends the error notification to the apparatus that has transmitted the search request.

(Step S191)

Upon completion of any of the process of retrieving a data provider in step S184, the process of retrieving a data acquirer in step S187, or the process of retrieving devices set definition information in step S190, the processing goes to step S191.

In step S191, the information registration and search server 32 acquires information relevant to the retrieved information from the data provider DB, the data acquirer DB, and the devices set definition DB, which are components of the information registration and search DB.

(Steps S192 and S193)

Next, in step S192, the information registration and search server 32 generates list data of the information retrieved from the DBs in step S191 and, in step S193, sends the list data back to the apparatus that has transmitted the search request.

(Step S194)

Finally, in step S194, the information registration and search server 32 determines whether or not to end the search process.

For example, if there is no new request from the apparatus that has made a search request, the process is ended. If there is any new request, the processing returns to step S181 again to start processing for the new request.

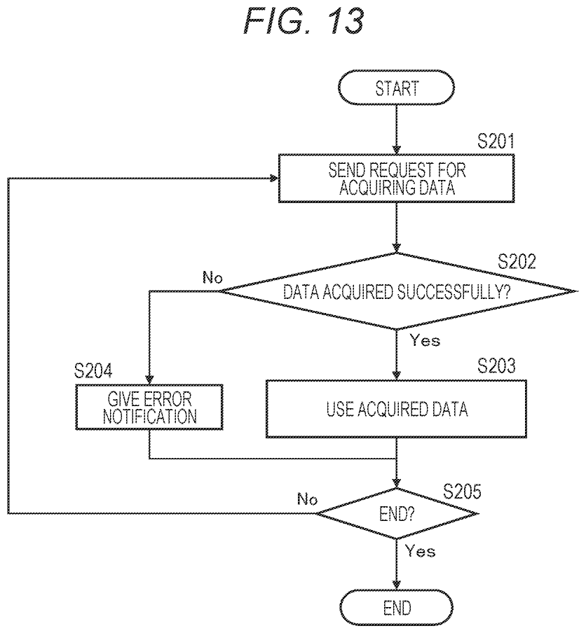

Referring to the flowchart shown in FIG. 13, the following describes the sequence of a process of acquiring data from the device-detected information providing server 31, the analysis information providing server 33, or the like to be performed by the data using apparatus 24 or the data analyzing apparatus 23.

The sequence of the process is executed when the data using apparatus 24 or the data analyzing apparatus 23 is going to acquire detected information stored in the detected information DB from the device-detected information providing server 31, or when the data using apparatus 24 or the data analyzing apparatus 23 is going to acquire analysis information stored in the analysis information DB from the analysis information providing server 33.

The following describes the individual process steps in the flow shown in FIG. 13.

(Step S201)

First, in step S201, the data using apparatus 24 or the data analyzing apparatus 23 sends a request for acquiring data to the server having the DB that stores the data to be acquired.

(Step S202)

Next, in step S202, the data using apparatus 24 or the data analyzing apparatus 23 determines whether or not the data has been successfully acquired. If the data acquisition has been unsuccessful, the processing goes to step S204 to display an error message and goes to step S205. If the data acquisition has been successful, the processing goes to step S203.

(Step S203)

If the data acquisition has been successful, in step S203, the data using apparatus 24 or the data analyzing apparatus 23 that has acquired the data performs both processes on the acquired data.

(Step S204)

Finally, in step S204, the data using apparatus 24 or the data analyzing apparatus 23 that has acquired the data determines whether or not to end the process of acquiring data.

For example, if the data acquisition is to be finished, the process is ended. If the data is to be acquired again or another piece of data is to be newly acquired, the processing returns to step S201 to start the process.

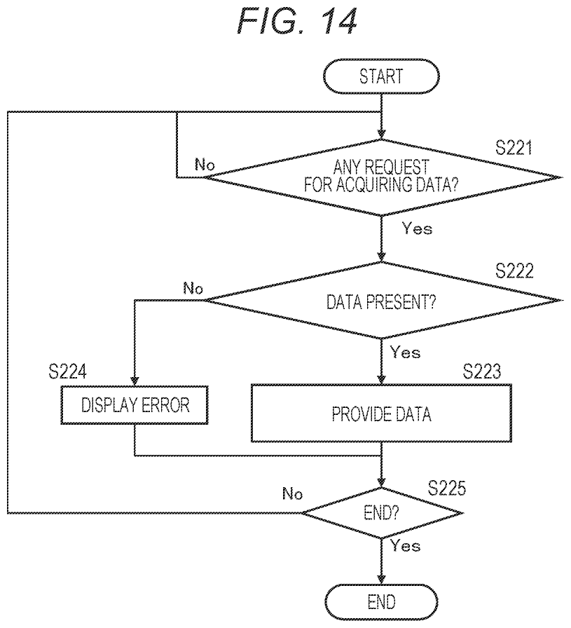

Referring to the flowchart shown in FIG. 14, the following describes the sequence of a process of providing data to be performed by the device-detected information providing server 31 or the analysis information providing server 33 that receives a request for acquiring data from the data using apparatus 24 or the data analyzing apparatus 23.

The following describes the individual process steps in the flow shown in FIG. 14.

(Step S221)

First, in step S221, the device-detected information providing server 31 or the analysis information providing server 33 determines whether or not there is a request for acquiring data sent from the data using apparatus 24, the data analyzing apparatus 23, or the like. If there is a request for acquiring data, the processing goes to step S222.

(Step S222)

Next, in step S222, the device-detected information providing server 31 or the analysis information providing server 33 determines whether or not the requested data is stored in the database.

If the requested data is absent, the processing goes to step S224 to give notification of an error, and goes to step S225.

If there is a request data, the processing goes to step S223.

(Step S223)

If it is determined that the requested data is present in step S222, the processing goes to step S223, acquires the requested data from the database, and sends the requested data.

(Step S224)

Finally, in step S224, it is determined whether or not to end the process of acquiring and sending data.

For example, if there is no new request, the process is ended. If there is any new request, the processing returns to step S221 again to start processing for the new request.

### 5. Database-Stored Data

The following describes the data stored in the individual databases managed by the information registration and search server 32 illustrated in FIG. 3, that is, the data stored in the data acquirer DB, the data provider DB, and the devices set definition DB.

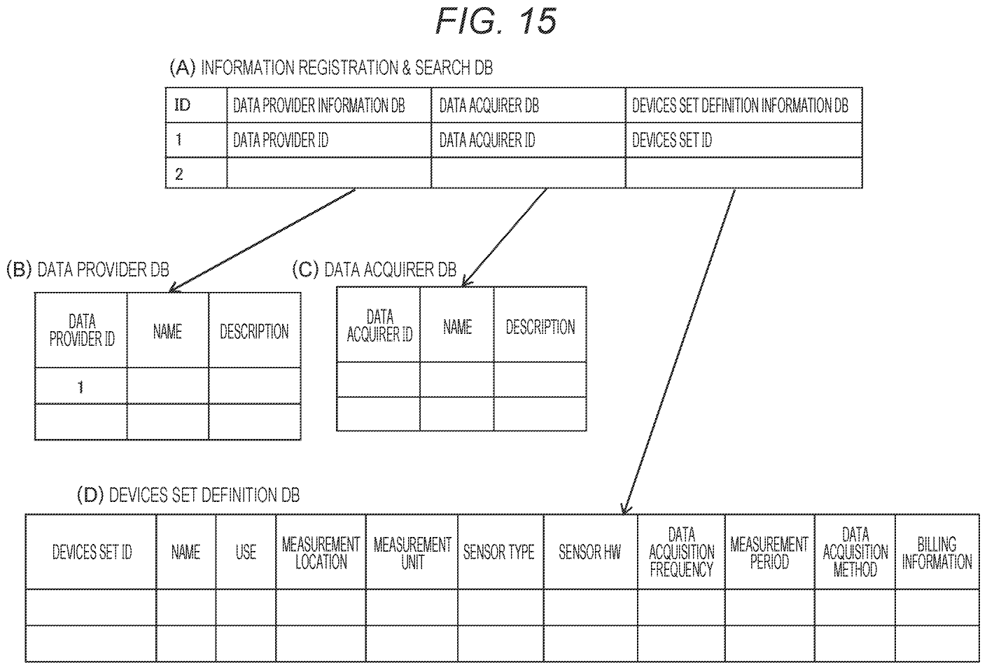

FIG. 15 is a diagram illustrating an example of the data stored in the individual databases, namely the data acquirer DB, the data provider DB, and the devices set definition DB managed by the information registration and search server 32.

As shown in FIG. 15, (A) Information registration and search DB managed by the information registration and search server 32 includes three sub-databases. That is, the following three databases are included.

(B) Data provider DB

(C) Data acquirer DB

(D) Devices set definition DB

The data provider DB is a database that stores information regarding the data providing apparatus 22 illustrated in FIG. 3. Note that although FIG. 3 shows only one data providing apparatus, a large number of data providing apparatuses are present on a network and the data provider DB stores information regarding the plurality of data providing apparatuses.

The data provider DB stores, for example, the following pieces of data associated with one another.

Data provider ID

Name: name of data provider Description: description of data provider

Reliability: reliability of data provider

The data acquirer DB is a database that stores information regarding the data acquiring apparatus 21 illustrated in FIG. 3. Note that although FIG. 3 shows only one data acquiring apparatus, a large number of data acquiring apparatuses are present on a network and the data acquirer DB stores information regarding the plurality of data acquiring apparatuses.

The data acquirer DB stores, for example, the following pieces of data associated with one another.

Data acquirer ID

Name: name of data acquirer Description: description of data acquirer

Reliability: reliability of data acquirer

Moreover, the devices set definition DB is a database that stores devices set definition information, that is, the devices set definition information including the pieces of data described above with reference to FIGS. 2 and 6.

The devices set definition DB stores, for example, the following pieces of data associated with one another.

Devices set ID (devices set ID)

Type: analysis data or measurement data

Name: name of devices set information Description: description of devices set information

Uses: agriculture, fishery, dairy, factories, earthquakes, weather, water quality, pollution, allergies, and so on

Measurement location: address (YY-cho Z-ZZ-ZZZ, XX-ku, Tokyo, or GPS location information)

Measurement unit: degree (temperature), degree (humidity), pH (alkalinity), m/s (wind force), G (acceleration), and so on

Sensor type: accelerometer, anemometer, thermometer, hygrometer, energometer, vibrometer, water flow meter, and so on

Sensor HW: manufacturer and model number

Number of sensors: e.g. 100

Data acquisition frequency: every minute, every second, every hour, 1 hz, 10 hz, and so on

Measurement period: for example, from YYYYMMDDThhmmss +0900 to YYYYMMDDThhmmss +0900

Data acquisition method: data acquisition URL, information regarding DVD purchase method, and so on

Billing information: fee, billing URL, bank account, and so on

Reliability: reliability of data information

The information registration and search server 32 shown in FIG. 3 manages the individual databases, namely the data acquirer DB, the data provider DB, and the devices set definition DB shown in FIG. 15, and searches data in response to a request from an external apparatus such as the data using apparatus 24, and provides a search result.

### 6. Configuration Enabling Origins and Generations of Database-Stored Data to be Identified

As shown in FIG. 3, a variety of data is stored in a plurality of databases in the information processing system of the present disclosure.

That is, the following databases are used:

the detected information DB managed by the device-detected information providing server (detected information storing unit) 31;

the data acquirer DB, the data provider type DB, and the devices set definition DB managed by the information registration and search server (registered information storing unit) 32;

the analysis information DB managed by the analysis information providing server (analysis information storing unit) 33; and

the billing information DB managed by the billing server (billing information storing unit) 34.

These databases each store a variety of data under management.

For example, the detected information DB managed by the device-detected information providing server (detected information storing unit) 31 sequentially accepts and stores the data acquired by the device acquiring apparatus 21 from devices.

Furthermore, the analysis information DB managed by the analysis information providing server (analysis information storing unit) 33 stores the analysis result data generated by the data analyzing apparatus 23 conducting an analysis process.

New data is sequentially added to and stored in these databases. For example, the analysis information DB of the analysis information providing server (analysis information storing unit) 33 may store a new analysis result that has been produced with a previous analysis result, and the relationship between these analysis results may become unclear.

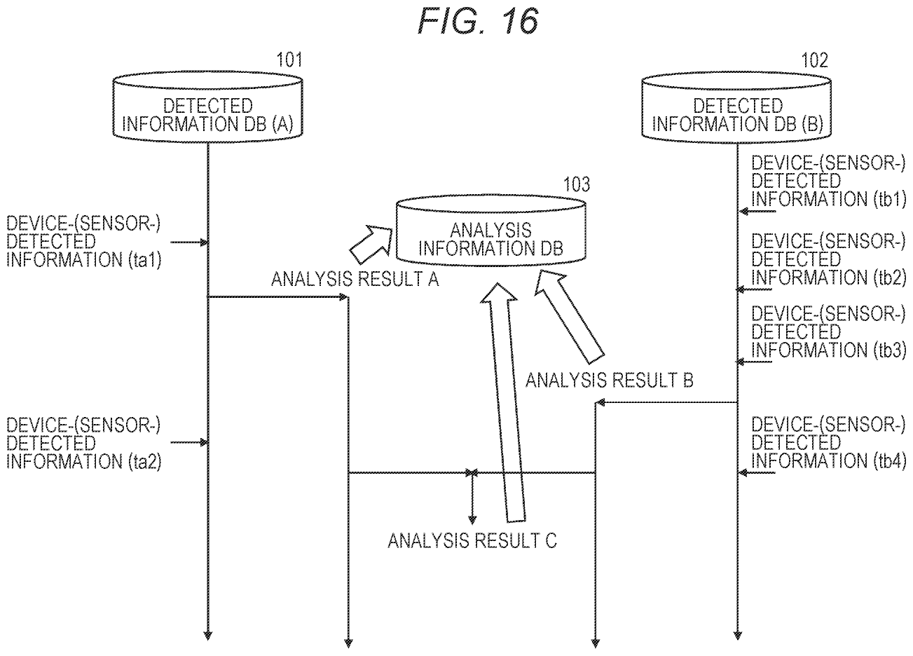

A specific example is described below with reference to the figures from FIG. 16.

FIG. 16 illustrates the sequence in which two databases, the detected information DB (A) 101 and the detected information DB (B) 102, each receive and store pieces of detected information from devices (sensors) at various timings, analysis processes are performed with these pieces of detected information, and analysis results are sequentially stored in the analysis information DB 103.

The pieces of device-(sensor-) detected information (ta1, ta2, tb1, . . . , and tb4) shown in FIG. 16 indicate inputs from a devices set including a plurality of devices (sensors) and their corresponding timings (ta1 to tb4).

These pieces of information are acquired by one or more data acquiring apparatuses and stored in the detected information DBs 101 and 102.

The data analyzing apparatus performs an analysis process using the device-detected information stored in the detected information DBs 101 and 102.

The analysis result A is an analysis result of the analysis process performed with the device-(sensor-) detected information (ta1) stored in the detected information DB (A) 101. The data analyzing apparatus stores the analysis result A in the analysis information DB 103.

Furthermore, the analysis result B is an analysis result of the analysis process performed with the device-(sensor-) detected information (tb1 to tb3) stored in the detected information DB (B) 102. The data analyzing apparatus stores the analysis result B in the analysis information DB 103.

Moreover, the analysis result C is an analysis result of the analysis process performed with the analysis result A and the analysis result B. The data analyzing apparatus stores the analysis result C in the analysis information DB 103.

As a result of the sequence, a plurality of analysis results (A to C) is stored in the analysis information DB 103. The user of the analysis information such as, for example, the data using apparatus 24 shown in FIG. 3 acquires analysis results from the analysis information DB to use these analysis results. However, the user has difficulty in understanding how the two or more analysis results stored in the analysis information DB are related and which piece of data was used to produce the analysis results.

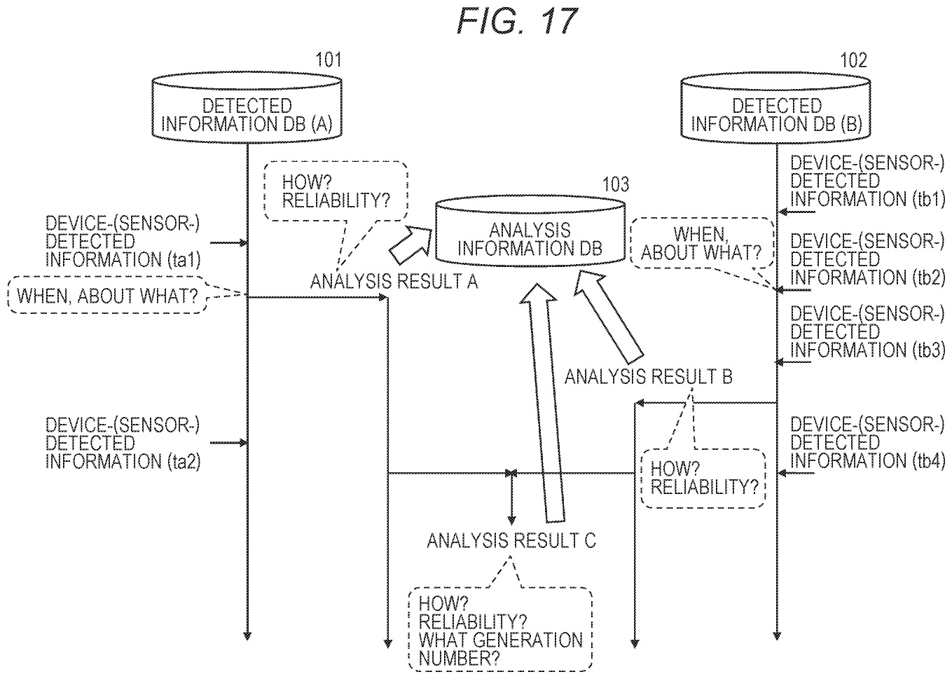

That is, as illustrated in FIG. 17, it is difficult to identify a specific data piece analyzed and a reliability level with regard to each analysis result.

The following describes a configuration of data pieces stored in a database intended to solve the problem.

In a process according to the present disclosure, when certain data such as an analysis result is stored in a database, generation information (generation) regarding the stored data is stored, as attribute information, in the DB together with the stored data.

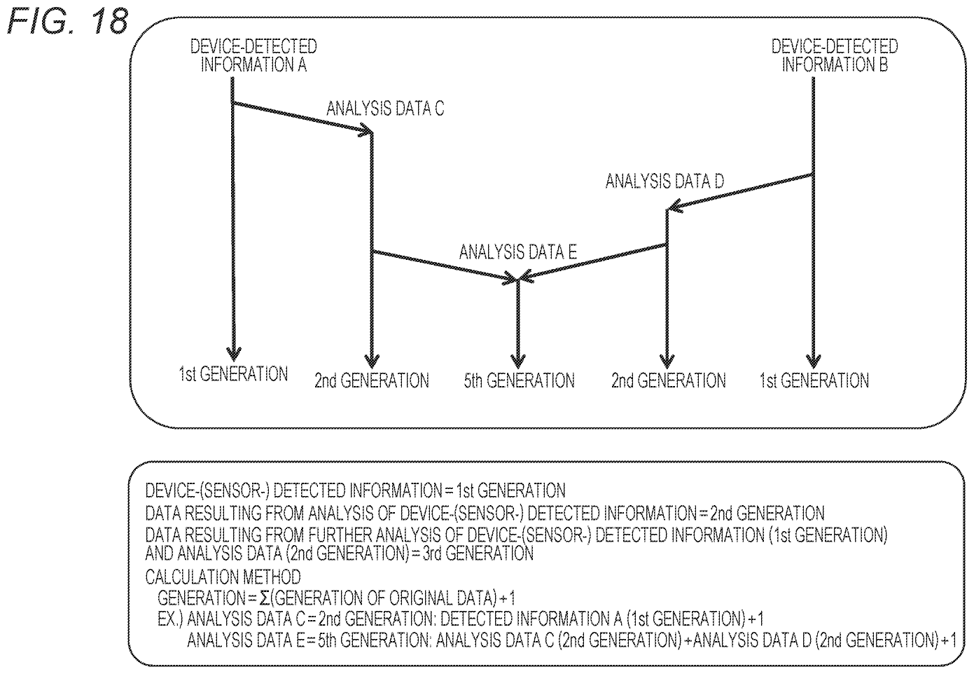

An example of a process of calculating the generation information is described below with reference to FIG. 18.

In the example illustrated in FIG. 18, the detected information stored in the detected information DB is defined as the first generation data, and the analysis data (analysis results C and D) resulting from an analysis process to which the detected information (first generation data) is applied is given a generation number obtained by adding the generation number =1 (+1) to the generation (1) of the detected information.

That is, the analysis results C and D represent second generation data.

The generation number of an analysis result of a subsequent analysis process performed with existing analysis data or detected information is obtained by adding the generation number of the analysis data or detected information used for the analysis process and further adding the generation number =1 (+1).

As shown in the lower part of FIG. 18, the analysis data C, for example, is an analysis result obtained by an analysis process performed with the detected information A, and therefore the analysis data C represents the second generation as obtained by adding +1 to the generation number =1 of the detected information A.

Furthermore, the analysis data E is an analysis result obtained by an analysis process with the analysis data C and the analysis data D, and therefore the analysis data E represents the fifth generation as obtained by adding +1 to the generation number =2 of the analysis data C and the generation number =2 of the analysis data D.

The generation information (generation) obtained by such process of calculating generation is recorded in the DB as attribute information of the database-stored data.

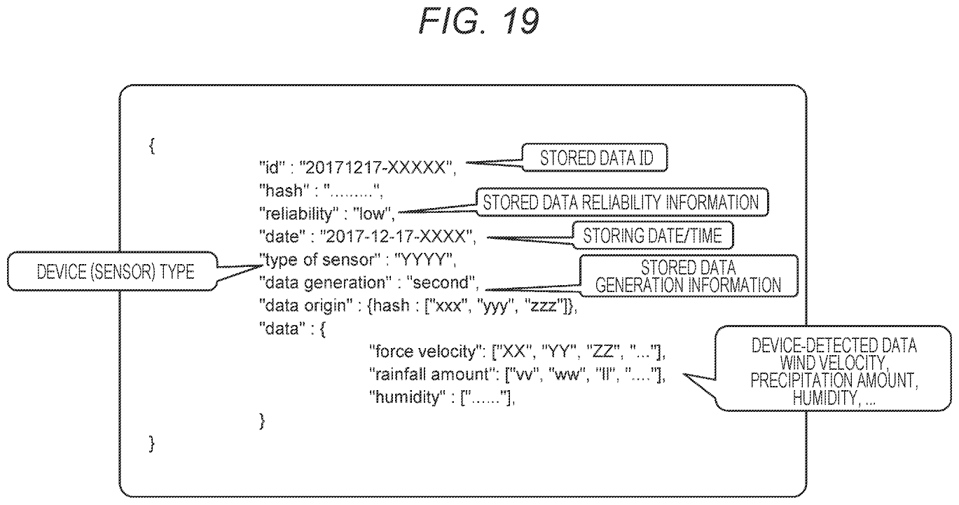

FIG. 19 shows an example of the database-stored data with generation information recorded.

The DB-stored data shown in FIG. 19 includes the following pieces of data:

stored data ID;

stored data reliability information;

storing date and time;

device (sensor) type;

stored data generation information; and

device-detected data.

The generation information, [second], is recorded in the stored data, making it possible to find that the data represents second generation data.

In addition, the stored data reliability information, [low], is recorded, also making it possible to find that the reliability of the data is low.

For example, an apparatus such as the data analyzing apparatus 23 or the data using apparatus 24 shown in FIG. 3 acquires the generation information recorded as the attribute information associated with the database-stored data, and performs a data analysis process or a data search process using the acquired generation information.

Note that, on an analysis result generated through a data analysis process by the data analyzing apparatus 23, the generation number of the analysis result is calculated in accordance with the above-described algorithm, followed by a process of storing the calculated generation number, as attribute information, in a database together with the analysis result.

### 7. Examples in which Data on a Network is Collected and Stored into Databases of the Information Registration and Search Server

The following describes an example in which data on a network is collected and stored into databases of the information registration and search server.

Information stored in various information providing servers on a network can be collected and recorded in the databases managed by the information registration and search server 32 shown in FIG. 3.

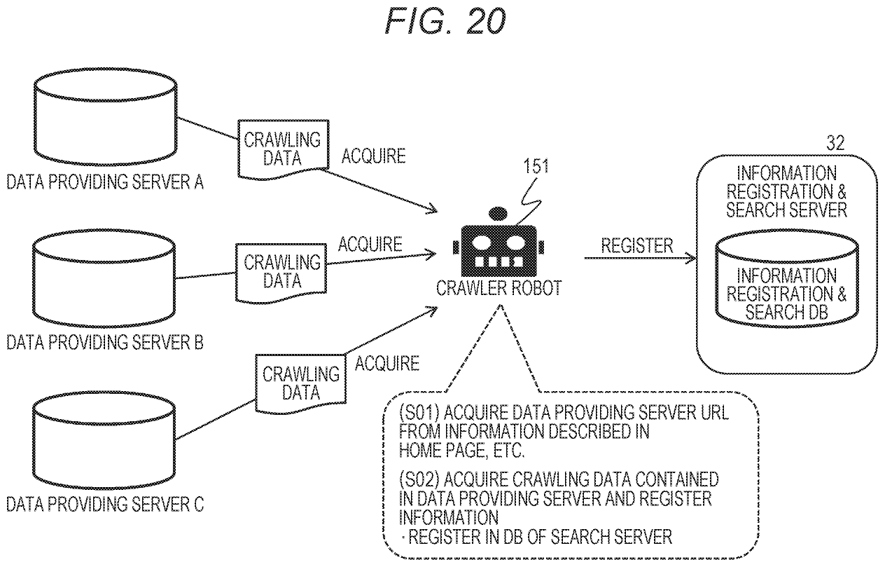

As illustrated in FIG. 20, a crawler robot 151 that automatically collects data from various data providing servers on a network is used to selectively store only the data that meets a preset collection condition in the information registration and search DB managed by the information registration and search server 32.

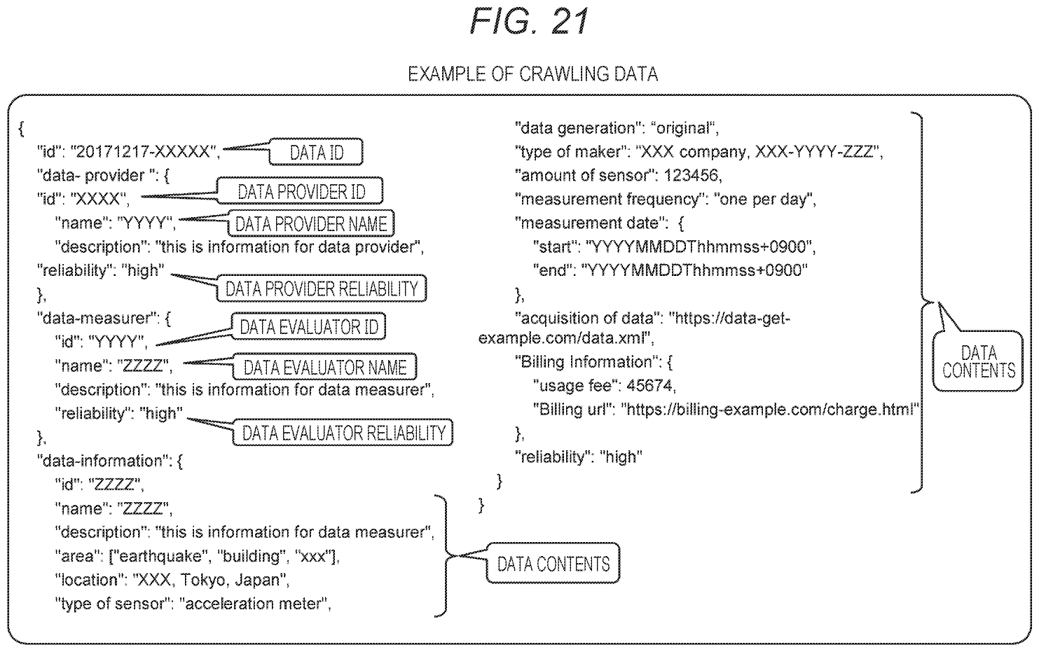

The data acquired through an automatic collection process by the crawler robot 151 is called crawling data. FIG. 21 shows an example of the crawling data.

The data shown in FIG. 21 includes pieces of data such as data ID, data provider ID, data provider name, data provider reliability, data evaluator ID, data evaluator name, data evaluator reliability, and data contents.

As a collection condition for the automatic data collection process to be performed by the crawler robot 151, a condition can be set to the effect that the data should include at least the following data pieces: data ID, data provider ID, data provider name, data provider reliability, data evaluator ID, data evaluator name, data evaluator reliability, and data contents, whereby only the data that includes these data pieces can be acquired from the DB connected to the network.

### 8. Example UIs Usable for Processes Including a Data Search Process

The following describes examples of the user interface (UI) that can be used for processes including a data search process.

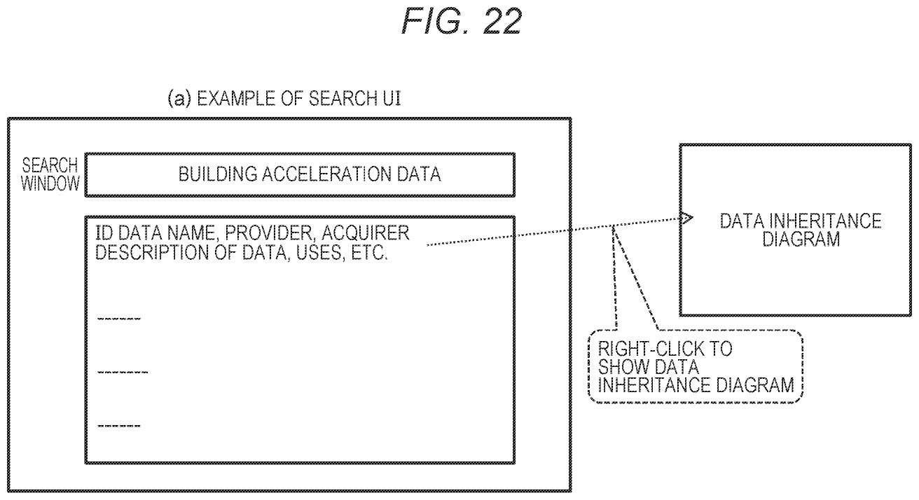

The user interface (UI) illustrated in FIG. 22(a) is an example UI through which an apparatus such as the data using apparatus 24 or the data analyzing apparatus 23 shown in FIG. 3 accesses the information registration and search server 32 to set a search condition.

The UI displays a search window where a search word is input and a presented information setting area where presented information is selected.

The user (searcher) can switch from the display area to a data inheritance diagram, which is the data inheritance diagram showing the data generation described above with reference to FIG. 18 by, for example, setting a mouse pointer on the user interface (UI) illustrated in FIG. 22(a) and right-clicking the mouse.

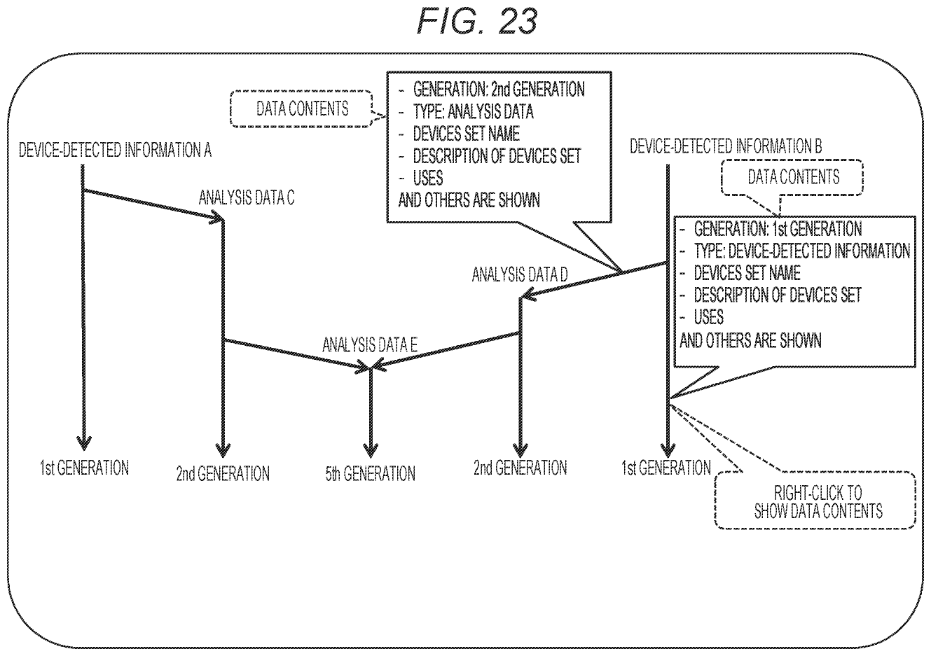

FIG. 23 shows an example screen to be shown after the switching. As illustrated in FIG. 23, the display area on the apparatus shows data indicating a relationship between data pieces and generation (a data inheritance diagram), which is similar to the data described above with reference to FIG. 18.

Moreover, detailed information corresponding to each line can be displayed when the user sets a mouse pointer on the line marked on the data inheritance diagram and right-clicks the mouse. As shown in the figure, the displayed detailed information includes data such as generation, type, devices set name, description of the devices set, and uses.

Furthermore, the user of the search data can additionally register new data to the data recorded in a database of the information registration and search server 32.

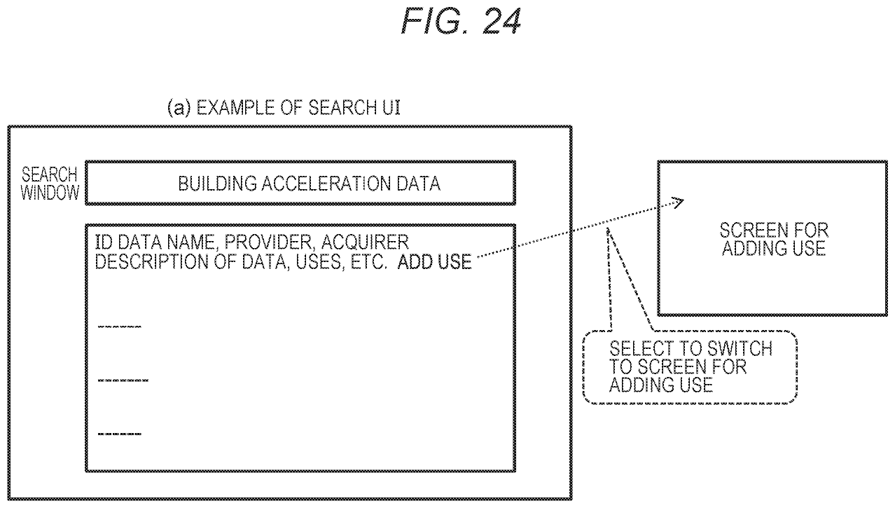

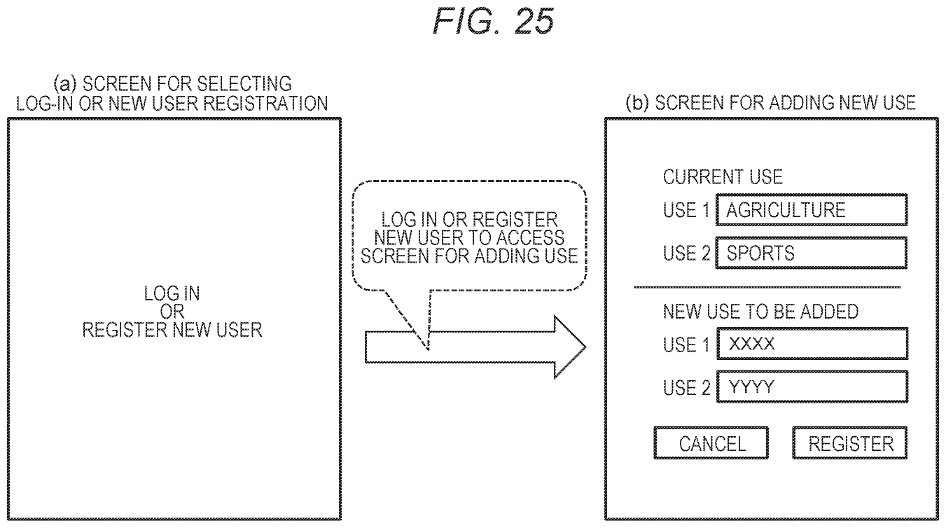

Referring to FIGS. 24 and 25, the following describes an example of transitioning between user interfaces during a process of adding data.

FIG. 24(a) is an example UI through which an apparatus such as the data using apparatus 24 or the data analyzing apparatus 23 shown in FIG. 3 accesses the information registration and search server 32 to set a search condition, as with the UI described above with reference to FIG. 22(a).

The UI displays a search window where a search word is input and a presented information setting area where presented information is selected.

The user can switch from the displayed data to a screen for adding a use by, for example, clicking to select “Add use” appearing in the presented information setting area.

FIG. 25 shows an example of the screen for adding a use.

Initially, a screen for selecting log-in or registration of a new user is presented as illustrated in FIG. 25(a). A screen for adding a new use as illustrated in FIG. 25(b) is presented by logging in according to a predefined process or performing a process of registering a new user on the current screen.

The user can additionally record the new use information relating to the data stored in a database of the information registration and search server 32 by inputting a new use and performing a registration process on this screen.

Note that, in a preferred configuration, the users allowed to perform such process are limited to those users who satisfy a predetermined condition, such as the users made up of specific members only. Furthermore, in another configuration, a process of giving some reward to the user who has carried out the process of adding information may be performed, such as, for example, offering points to the user.

### 9. Example Hardware Configuration of the Information Processing Apparatus

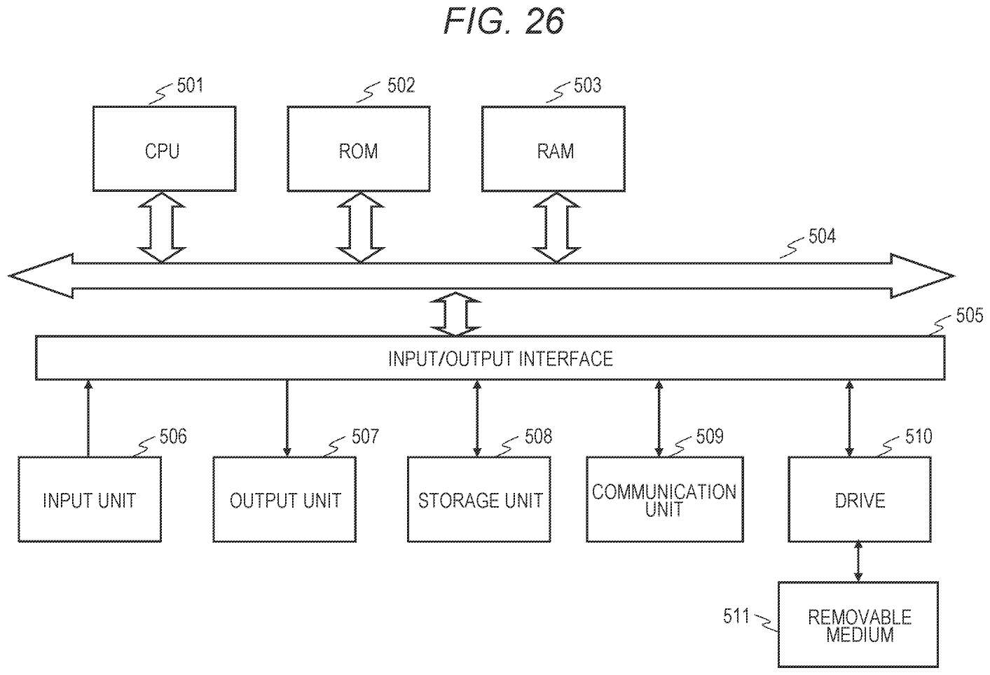

Referring to FIG. 26, the following describes an example hardware configuration of the information processing apparatus that includes the individual components illustrated in FIG. 3, that is, the data acquiring apparatus 21, the data providing apparatus 22, the data analyzing apparatus 23, the data using apparatus 24, the device-detected information providing server (detected information storing unit) 31, the information registration and search server (registered information storing unit) 32, the analysis information providing server (analysis information storing unit) 33, and the billing server (billing information storing unit) 34.

A central processing unit (CPU) 501 functions as a control unit and a data processing unit that perform various processes in accordance with a program stored in a read only memory (ROM) 502 or a storage unit 508. For example, the CPU performs a process in accordance with the sequence described in the above-described example. A random access memory (RAM) 503 stores programs to be executed by the CPU 501, data, and the like. The CPU 501, the ROM 502, and the RAM 503 are connected to one another by a bus 504.

The CPU 501 is connected to an input/output interface 505 via the bus 504. The input/output interface 505 is connected with an input unit 506 that includes various switches, a keyboard, a mouse, a microphone, a sensor, and the like, and with an output unit 507 that includes a display, a speaker, and the like. The CPU 501 performs various processes in response to a command that is input from the input unit 506, and outputs a processing result to, for example, the output unit 507.

The storage unit 508 connected to the input/output interface 505 includes, for example, a hard disk and the like to store programs to be executed by the CPU 501 and various types of data. A communication unit 509, which functions as a transmission and reception unit for Wi-Fi communications, Bluetooth (registered trademark) (BT) communications, and other data communications via a network such as the Internet, a local area network, or the like, communicates with an external apparatus.

A drive 510 connected to the input/output interface 505 drives a removable medium 511, such as a magnetic disk, an optical disk, a magneto-optical disk, or a semiconductor memory such as a memory card, to record or read data.

### 10. Summary of Configurations of the Present Disclosure

The foregoing has described examples of the present disclosure in detail, referring to specific examples. However, it is apparent that those skilled in the art can make modifications or substitutions of the examples without departing from the gist of the present disclosure. That is, the present invention has been disclosed in the form of an example and should not be construed as limiting. In order to determine the gist of the present disclosure, the claims should be taken into consideration.

The technology disclosed herein can have the following configurations.

(1) An information processing apparatus including:

a data processing unit that performs a data analysis process using device-detected information, in which

the data processing unit acquires devices set definition information, which is definition information in a unit of a devices set including a plurality of devices, and performs the data analysis process to which the acquired devices set definition information is applied.

(2) The information processing apparatus according to (1), in which

the data processing unit acquires device attribute information in a unit of the devices set from the devices set definition information, and performs the data analysis process to which the acquired device attribute information in a unit of the devices set is applied.

(3) The information processing apparatus according to (2), in which

the device attribute information includes position information regarding a device included in the devices set.

(4) The information processing apparatus according to (2) or (3), in which

the devices include a sensor, and the device attribute information includes type information regarding the sensor included in the devices set.

(5) The information processing apparatus according to any one of (1) to (4), in which

the data processing unit acquires the devices set definition information from a devices set definition database storing the devices set definition information.

(6) The information processing apparatus according to any one of (1) to (5), in which

the data processing unit acquires generation information recorded as attribute information associated with database-stored data, and performs the data analysis process using the acquired generation information.

(7) The information processing apparatus according to any one of (1) to (6), in which

the data processing unit calculates, on an analysis result generated by the data analysis process, generation number of the analysis result in accordance with a predetermined algorithm, and performs a process of storing the calculated generation number, as attribute information, in a database together with the analysis result.

(8) An information processing apparatus including:

a data processing unit that performs a data search process using device-detected information, in which

the data processing unit acquires devices set definition information, which is definition information in a unit of a devices set including a plurality of devices, and performs the data search process to which the acquired devices set definition information is applied.

(9) The information processing apparatus according to (8), in which

the data processing unit acquires device attribute information in a unit of the devices set from the devices set definition information, and performs the data search process to which the acquired device attribute information in a unit of the devices set is applied.

(10) The information processing apparatus according to (8) or (9), in which

the data processing unit acquires the devices set definition information from a devices set definition database storing the devices set definition information.

(11) The information processing apparatus according to any one of (8) to (10), in which

the data processing unit acquires generation information recorded as attribute information associated with database-stored data, and performs the data search process using the acquired generation information.

(12) An information processing apparatus including:

a data processing unit that generates devices set definition information, which is definition information in a unit of a devices set including a plurality of devices, and registers the devices set definition information in a database.

(13) The information processing apparatus according to (12), in which

the data processing unit generates the devices set definition information that includes device attribute information in a unit of the devices set.

(14) An information processing system including:

a data providing apparatus that generates devices set definition information, which is definition information in a unit of a devices set including a plurality of devices, and registers the devices set definition information in a database; and

a data analyzing apparatus that acquires the devices set definition information from the database and performs a data analysis process to which the acquired devices set definition information is applied.

(15) The information processing system according to (14), further including:

a data using apparatus that acquires the devices set definition information from the database and performs a data search process to which the acquired devices set definition information is applied.

(16) An information processing method performed in an information processing apparatus, in which

the information processing apparatus includes a data processing unit that performs a data analysis process using device-detected information, and

the information processing method includes:

acquiring devices set definition information, which is definition information in a unit of a devices set including a plurality of devices, and performing the data analysis process to which the acquired devices set definition information is applied, the acquiring and the performing being carried out by the data processing unit.

(17) An information processing method performed in an information processing apparatus, in which

the information processing apparatus includes a data processing unit that performs a data search process using device-detected information, and

the information processing method includes:

acquiring devices set definition information, which is definition information in a unit of a devices set including a plurality of devices, and performing the data search process to which the acquired devices set definition information is applied, the acquiring and the performing being carried out by the data processing unit.

(18) A program causing an information processing apparatus to perform information processing, in which

the information processing apparatus includes a data processing unit that performs a data analysis process using device-detected information, and

the program causes the data processing unit to:

acquire devices set definition information, which is definition information in a unit of a devices set including a plurality of devices, and perform the data analysis process to which the acquired devices set definition information is applied.

(19) A program causing an information processing apparatus to perform information processing, in which

the information processing apparatus includes a data processing unit that performs a data search process using device-detected information, and

the program causes the data processing unit to:

acquire devices set definition information, which is definition information in a unit of a devices set including a plurality of devices, and perform the data search process to which the acquired devices set definition information is applied.

The series of processes described herein can be performed with hardware, software, or a configuration in which hardware and software are combined. In the case of performing the processes with software, a program in which the process sequence is recorded can be installed and executed in a memory in a computer incorporated in dedicated hardware, or can be installed and executed in a general-purpose computer capable of performing various processes. For example, the program can be recorded in a recording medium in advance. In addition to being installed in a computer from the recording medium, the program can be received via a network such as a local area network (LAN) or the Internet and installed in a recording medium such as a built-in hard disk.

Note that the various processes described herein may be performed not only in time series in accordance with the description but also in parallel or separately, depending on the processing capability of the apparatus performing the processes or on an as-needed basis. In addition, the system as used herein is a logical assembly of a plurality of apparatuses, and the apparatuses having their respective configurations may not necessarily be in the same housing.

### INDUSTRIAL APPLICABILITY

As described above, according to the configuration of one example of the present disclosure, a configuration is implemented making it possible to perform a data analysis and a search process using devices set definition information, which is definition information in a unit of a devices set including a plurality of devices.

Specifically, the configuration includes, for example, a data providing apparatus that generates devices set definition information, which is definition information in a unit of a devices set including a plurality of devices, and registers the devices set definition information in a database, and a data analyzing apparatus and a data using apparatus that acquire the devices set definition information from the database and perform a data analysis process or a search process to which the acquired devices set definition information is applied. Data analyses and search processes with the devices set definition information achieve improved processing efficiency and generation of various analysis results.

According to this configuration, a configuration is implemented making it possible to perform a data analysis and a search process using devices set definition information, which is definition information in a unit of a devices set including a plurality of devices.

### REFERENCE SIGNS LIST

21 Data acquiring apparatus
22 Data providing apparatus
23 Data analyzing apparatus
24 Data using apparatus
31 Device-detected information providing server (detected information storing unit)
32 Information registration and search server (registered information storing unit)
33 Analysis information providing server (analysis information storing unit)
34 Billing server (billing information storing unit)
101, 102 Detection upper database
103 Analysis information database
151 Crawler robot
501 CPU
502 ROM
503 RAM
504 Bus
505 Input/output interface
506 Input unit
507 Output unit
508 Storage unit
509 Communication unit
510 Drive
511 Removable medium

1. An information processing apparatus comprising:
a data processing unit that performs a data analysis process using device-detected information, wherein
the data processing unit acquires devices set definition information, which is definition information in a unit of a devices set including a plurality of devices, and performs the data analysis process to which the acquired devices set definition information is applied.

2. The information processing apparatus according to claim 1, wherein
the data processing unit acquires device attribute information in a unit of the devices set from the devices set definition information, and performs the data analysis process to which the acquired device attribute information in a unit of the devices set is applied.

3. The information processing apparatus according to claim 2, wherein
the device attribute information includes position information regarding a device included in the devices set.

4. The information processing apparatus according to claim 2, wherein
the devices include a sensor, and the device attribute information includes type information regarding the sensor included in the devices set.

5. The information processing apparatus according to claim 1, wherein
the data processing unit acquires the devices set definition information from a devices set definition database storing the devices set definition information.

6. The information processing apparatus according to claim 1, wherein
the data processing unit acquires generation information recorded as attribute information associated with database-stored data, and performs the data analysis process using the acquired generation information.

7. The information processing apparatus according to claim 1, wherein
the data processing unit calculates, on an analysis result generated by the data analysis process, generation number of the analysis result in accordance with a predetermined algorithm, and performs a process of storing the calculated generation number, as attribute information, in a database together with the analysis result.

8. An information processing apparatus comprising:
a data processing unit that performs a data search process using device-detected information, wherein
the data processing unit acquires devices set definition information, which is definition information in a unit of a devices set including a plurality of devices, and performs the data search process to which the acquired devices set definition information is applied.

9. The information processing apparatus according to claim 8, wherein
the data processing unit acquires device attribute information in a unit of the devices set from the devices set definition information, and performs the data search process to which the acquired device attribute information in a unit of the devices set is applied.

10. The information processing apparatus according to claim 8, wherein
the data processing unit acquires the devices set definition information from a devices set definition database storing the devices set definition information.

11. The information processing apparatus according to claim 8, wherein
the data processing unit acquires generation information recorded as attribute information associated with database-stored data, and performs the data search process using the acquired generation information.

12. An information processing apparatus comprising:
a data processing unit that generates devices set definition information, which is definition information in a unit of a devices set including a plurality of devices, and registers the devices set definition information in a database.

13. The information processing apparatus according to claim 12, wherein
the data processing unit generates the devices set definition information that includes device attribute information in a unit of the devices set.

14. An information processing system comprising:
a data providing apparatus that generates devices set definition information, which is definition information in a unit of a devices set including a plurality of devices, and registers the devices set definition information in a database; and
a data analyzing apparatus that acquires the devices set definition information from the database and performs a data analysis process to which the acquired devices set definition information is applied.

15. The information processing system according to claim 14, further comprising:
a data using apparatus that acquires the devices set definition information from the database and performs a data search process to which the acquired devices set definition information is applied.

16. An information processing method performed in an information processing apparatus, wherein
the information processing apparatus comprises a data processing unit that performs a data analysis process using device-detected information, and
the information processing method comprises:
acquiring devices set definition information, which is definition information in a unit of a devices set including a plurality of devices, and performing the data analysis process to which the acquired devices set definition information is applied, the acquiring and the performing being carried out by the data processing unit.

17. An information processing method performed in an information processing apparatus, wherein
the information processing apparatus comprises a data processing unit that performs a data search process using device-detected information, and
the information processing method comprises:
acquiring devices set definition information, which is definition information in a unit of a devices set including a plurality of devices, and performing the data search process to which the acquired devices set definition information is applied, the acquiring and the performing being carried out by the data processing unit.

18. A program causing an information processing apparatus to perform information processing, wherein
the information processing apparatus comprises a data processing unit that performs a data analysis process using device-detected information, and
the program causes the data processing unit to:
acquire devices set definition information, which is definition information in a unit of a devices set including a plurality of devices, and perform the data analysis process to which the acquired devices set definition information is applied.

19. A program causing an information processing apparatus to perform information processing, wherein
the information processing apparatus comprises a data processing unit that performs a data search process using device-detected information, and
the program causes the data processing unit to:
acquire devices set definition information, which is definition information in a unit of a devices set including a plurality of devices, and perform the data search process to which the acquired devices set definition information is applied.
